(19) United States
(12) Patent Application Publication
(10) Pub. No.: US 2010/0153227 A1
(43) Pub. Date: Jun. 17, 2010

(54) MOBILE PHONE BILLING FOR CONTENT PAYMENT

(75) Inventors: Gennady Medvinsky, Redmond, WA (US); David EW Mercer, Bothell, WA (US); Thomas M. Chirichigno, Woodinville, WA (US); Rahul Dhar, Seattle, WA (US); Cid Halloway, Santa Cruz, CA (US); Andrew Jenks, Redmond, WA (US); Hugh A. Teegan, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/489,068

(22) Filed: Jun. 22, 2009

Related U.S. Application Data
(60) Provisional application No. 61/122,226, filed on Dec. 12, 2008.

(51) Int. Cl. G06Q 30/00; G06Q 50/00; G06Q 10/00; H04M 3/42

(52) U.S. Cl. 705/26; 705/34; 455/414.1

(57) ABSTRACT

Mobile phone billing for content payment is described. In embodiments, a media content provider receives a billing identifier that is associated with a mobile phone. The billing identifier is received from a communication service provider that authenticates the mobile phone for communications, and a network communication link is established between the mobile phone and the media content provider via the communication service provider. The media content provider receives a request from the mobile phone to purchase and download a media asset. The media content provider determines the billing identifier that is associated with the mobile phone for the purchase of the media asset, and communicates a charge for the media asset to the communication service provider that then bills a user associated with the mobile phone. The user that is associated with the mobile phone is billed for the media asset in a mobile phone service bill.

### RELATED APPLICATION

This application claims priority to U.S. Provisional Application Ser. No. 61/122,226 filed Dec. 12, 2008, entitled “Mobile Phone Billing as a Payment Mechanism for OTA and Wi-Fi Initiated Transactions” to Medvinsky et al., the disclosure of which is incorporated by reference herein in its entirety.

### BACKGROUND

Mobile phones and other portable communication devices are increasingly being utilized as network-connected, general purpose computing devices. In addition to traditional features such as voice services and messaging services (e.g., SMS and MMS), new mobile phone features include value added data plans that range from general Internet connectivity for Web browsing and email to multi-media on-demand content delivery, as well as local application data sync to network-based services. While voice and messaging services still form the core business for mobile operators, premium data plans based on partnerships between mobile operators and service providers are emerging as a new, viable business model.

### SUMMARY

This summary is provided to introduce simplified concepts of mobile phone billing for content payment. The simplified concepts are further described below in the Detailed Description. This summary is not intended to identify essential features of the claimed subject matter, nor is it intended for use in determining the scope of the claimed subject matter.

Mobile phone billing for content payment is described. In embodiments, a media content provider receives a billing identifier that is associated with a mobile phone. The billing identifier is received from a communication service provider that authenticates the mobile phone for communications, and a network communication link is established between the mobile phone and the media content provider via the communication service provider. The media content provider receives a request from the mobile phone to purchase and download a media asset. The media content provider determines the billing identifier that is associated with the mobile phone for the purchase of the media asset, and communicates a charge for the media asset to the communication service provider that then bills a user associated with the mobile phone. The user that is associated with the mobile phone is billed for the media asset in a mobile phone service bill.

In other embodiments, the media content provider establishes a network communication link with the mobile phone via a communication network that bypasses the communication service provider. Another request can be received from the mobile phone to purchase and download an additional media asset from the media content provider via the network communication link. An additional charge for the additional media asset is communicated to the communication service provider that then bills the user associated with the mobile phone for the additional media asset. The user that is associated with the mobile phone is billed for the additional media asset in the mobile phone service bill that the user receives from the communication service provider.

In other embodiments, a communication service provider receives a request from a mobile phone to establish a mobile communication link to a media content provider from which media assets can be purchased and downloaded. The communication service provider can authenticate the mobile phone for communications via the communication service provider, and establish the mobile communication link between the mobile phone and the media content provider to facilitate a purchase of a media asset that is downloaded to the mobile phone. The communication service provider can also communicate a billing identifier that is associated with the mobile phone to the media content provider that maintains a database of billing identifiers. The communication service provider then receives a charge for the media asset from the media content provider where the charge for the media asset is associated with the mobile phone by the billing identifier. The communication service provider can then bill a user that is associated with the mobile phone for the media asset according to the charge for the media asset that is received from the media content provider. The user that is associated with the mobile phone is billed for the media asset in a mobile phone service bill.

### BRIEF DESCRIPTION OF THE DRAWINGS

Embodiments of mobile phone billing for content payment are described with reference to the following drawings. The same numbers are used throughout the drawings to reference like features and components:

FIG. 1 illustrates an example system in which embodiments of mobile phone billing for content payment can be implemented.

FIGS. 2 and 3 illustrate example methods for mobile phone billing for content payment at a media content provider in accordance with one or more embodiments.

FIGS. 4 and 5 illustrate example methods for mobile phone billing for content payment at a communication service provider in accordance with one or more embodiments.

FIG. 6 illustrates various components of an example device that can implement embodiments of mobile phone billing for content payment.

### DETAILED DESCRIPTION

Embodiments of mobile phone billing for content payment provide that mobile phone billing can be utilized as a general purpose payment mechanism for over-the-air (OTA) and Wi-Fi transactions initiated with a mobile phone. Phone bill charges can be initiated by a media content provider when a trusted relationship is established with a communication service provider (also referred to herein as a mobile operator). Phone bill charges can be applied to the mobile phone bill of a user even when the subscriber is connected directly to the Internet, such as via Wi-Fi without an OTA connection. In the various embodiments described herein, OTA refers to data transferred over the Mobile Network Operators mobile data network infrastructure (e.g. UMTS/GSM/CDMA2000) as opposed to connections made over non-MNO networks (e.g. public Wi-Fi hotspots). Wi-Fi is specified in the IEEE 802.11 set of standards.

In various embodiments, a media content provider can add per transaction charges to a mobile phone bill of a user, such as for e-commerce transactions that take place via a mobile operator's over-the-air network (e.g., GSM or CDMA). Access to the media content provider may also be available via another network communication link. Rather than connecting over-the-air, a mobile phone customer may connect via Wi-Fi for example, and access the media content provider directly over the Internet. Users may be compelled to take this path while in proximity to Wi-Fi hotspots to minimize over-the-air related usage charges. Various embodiments of mobile phone billing for content payment are described herein. In addition, the various embodiments pertain to GSM based networks for mobile phones, and/or the architecture and mechanisms described herein are also applicable and relevant to CDMA based cellular networks.

While features and concepts of the described systems and methods for mobile phone billing for content payment can be implemented in any number of different environments, systems, and/or various configurations, embodiments of mobile phone billing for content payment are described in the context of the following example systems and environments.

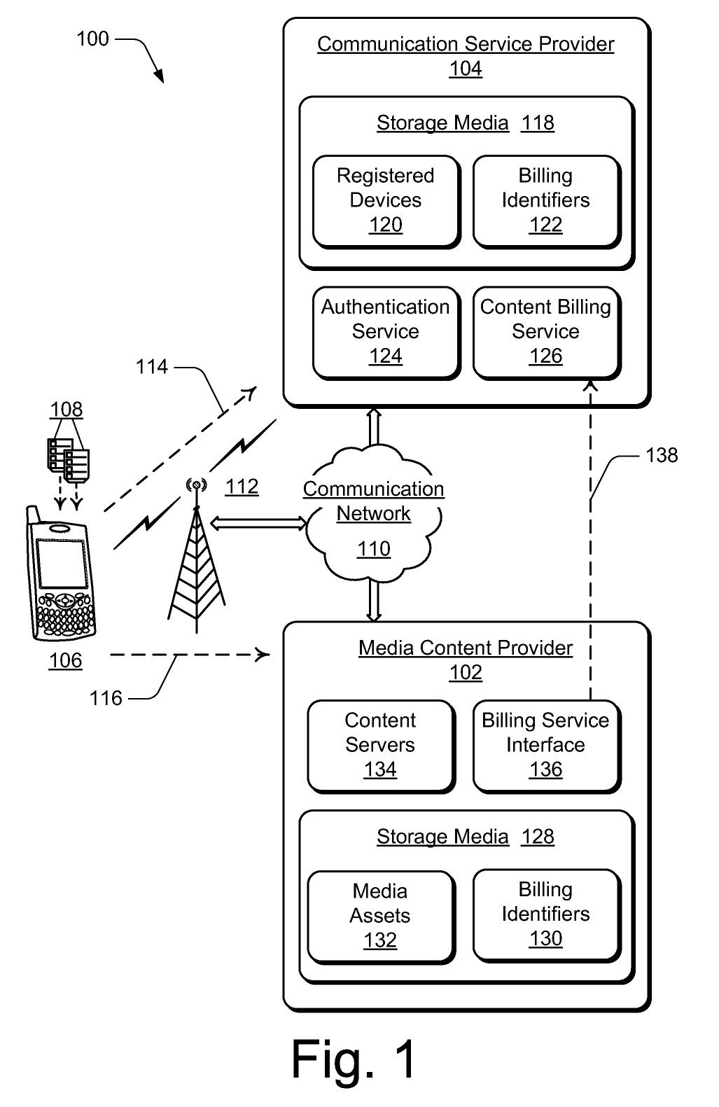

FIG. 1 illustrates an example system 100 in which various embodiments of mobile phone billing for content payment can be implemented. In this example, system 100 includes a media content provider 102 and a communication service provider 104 that facilitates mobile data and/or voice communications. A communication service provider is also commonly referred to as a mobile operator, and may be a cell-phone provider and/or an Internet service provider. The communication service provider 104 enables data and/or voice communications for any type of a mobile device or mobile phone 106 (e.g., cellular, VoIP, WiFi, etc.), and/or any other wireless media or communication device that can receive data, voice, or media content in any form of audio, video, and/or image data.

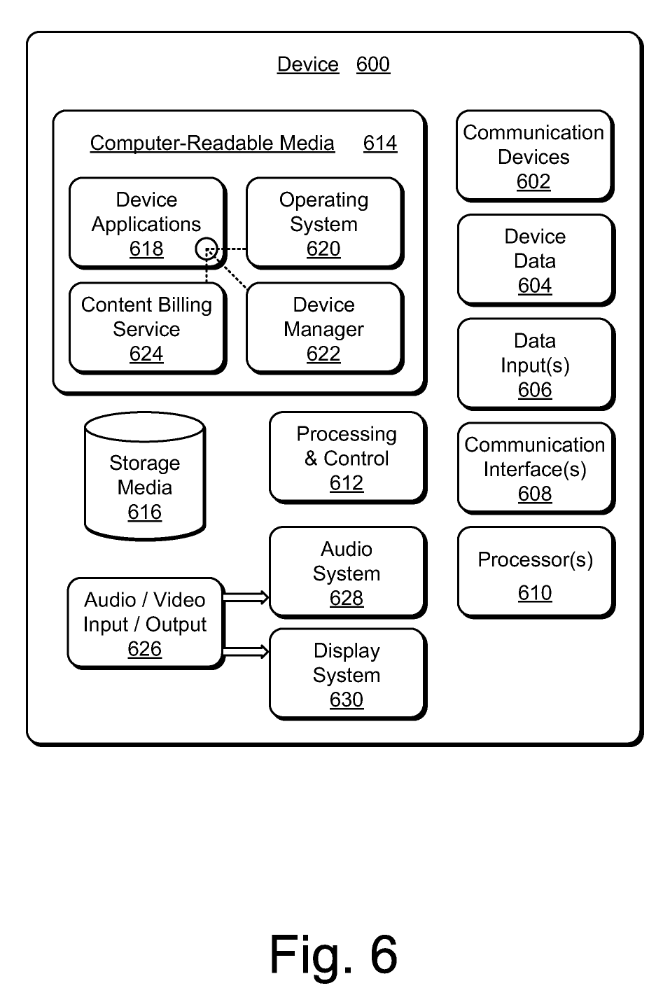

A mobile device (e.g., to include mobile phone 106) can be implemented with one or more processors, communication components, memory components, and signal processing and control circuits. Further, a mobile device can be implemented with any number and combination of differing components as further described with reference to the example device shown in FIG. 6. A mobile device may also be associated with a user or owner (i.e., a person) and/or an entity that operates the device such that a mobile device describes logical devices that include users, software, and/or a combination of devices.

The mobile phone 106 can include or have any number of associated Subscriber Identity Modules (SIMs) 108. By way of an example, a user that is associated with mobile phone 106 has a subscription-based relationship with a mobile operator (e.g., the communication service provider 104). In an implementation, the mobile phone 106 is a GSM phone that is utilized with the different SIMs 108. A SIM is a temper resistant smartcard that maintains a unique identifier, such as an International Mobile Subscriber Identity (IMSI) and a cryptographic key (referred to as a K).

For each SIM, the mobile operator maintains a corresponding record in a data store that includes the IMSI to K mapping. The SIM can perform cryptographic operations on the card (i.e., signing, hashing, RNG, encrypt/decrypt), and can implement a security protocol with the mobile operator without the K leaving the SIM, and by using the mobile phone for pass-through of messages. The mobile phone itself is a computer device that can execute an operating system with networking capabilities, such as OTA (over-the-air) and/or Wi-Fi, along with Internet protocol stack support (TCP/IP, HTTP, HTTPS, etc.).

The user that is associated with mobile phone 106 may also have a relationship with the media content provider 102, and a user identity and corresponding security credentials are issued by the media content provider, or by a third party identity provider that is trusted by the media content provider. Using the mobile phone 106, the user can authenticate to the media content provider and purchase media assets and/or services (e.g., download to own a movie, a digital music file, and the like). The authentication credentials may persist on the mobile phone 106 and can take any number of forms, including: user name and password; public key based certificate and corresponding private key; and/or a one time password. Furthermore these credentials may be combined with other form factors (e.g., Biometrics) for added security. These credentials can also be utilized when generating billable events, and can be selected based on their security characteristics.

A communication network 110 can be implemented to include any type of a data network, voice network, broadcast network, an IP-based network, and/or a wireless network 112 that facilitates data and/or voice communication between the media content provider 102, communication service provider 104, and mobile phone 106. The communication network 110 can be implemented using any type of network topology and/or communication protocol, and can be represented or otherwise implemented as a combination of two or more networks. In this example system 100, the mobile phone 106 communicates with the communication service provider 104 over-the-air (OTA) via a mobile communication link 114. In the various embodiments described herein, OTA refers to data transferred over the Mobile Network Operators mobile data network infrastructure (e.g. UMTS/GSM/CDMA2000) as opposed to connections made over non-MNO networks (e.g. public Wi-Fi hotspots). The mobile phone 106 can also communicate with the media content provider 102 via a network communication link 116, such as via the Internet, bypassing the communication service provider 104.

The communication service provider 104 includes storage media 118 to store or otherwise maintain various data, such as a database of registered devices 120 and billing identifiers 122. The storage media 118 can be implemented as any type of memory, random access memory (RAM), a nonvolatile memory such as flash memory, read only memory (ROM), a removable storage device, and/or other suitable electronic data storage. The database of registered devices 120 can include an identifier of mobile phone 106 that is registered with the communication service provider 104, such as for a cell phone data and service connection plan. A billing identifier 122 can be established as a unique identifier that is associated with a particular user of mobile phone 106, such as an ACR which is a unique billing identifier. The unique identifier can include any one or combination of a user identifier, a device identifier, a phone identifier, a phone number, and any other identifier that can be utilized to correlate billing a user for media content purchases and downloads.

The communication service provider 104 also includes an authentication service 124 to authenticate the mobile phone 106 for communications via the communication service provider. The communication service provider 104 also includes a content billing service 126 that can be implemented as computer-executable instructions and executed by processor(s) to implement the various embodiments and/or features of mobile phone billing for content payment as described herein. In addition, the communication service provider 104 can be implemented with any number and combination of differing components as further described with reference to the example device shown in FIG. 6.

The media content provider 102 includes storage media 128 to store or otherwise maintain various data and media content, such as a database of billing identifiers 130 and media assets 132. The storage media 128 can be implemented as any type of memory, random access memory (RAM), a nonvolatile memory such as flash memory, read only memory (ROM), a removable storage device, and/or other suitable electronic data storage. The media assets 132 can include any type of audio, video, and/or image media content received from any media content and/or data source. The media assets can include music files, videos, ringtones, television programs (or programming), advertisements, commercials, movies, video clips, data feeds, interactive games, network-based applications, and any other content or data that can be purchased and downloaded to mobile phone 106.

The media content provider 102 includes one or more content servers 134 that are implemented to communicate, or otherwise distribute, the media assets 132 and/or other data to any number of various client devices when the media assets 132 are purchased and downloaded. The media content provider 102 also includes a billing service interface 136 which can be implemented as an interface to the content billing service 126 at the communication service provider 104 for content charges 138.

The mobile phone 106 can facilitate the purchase of a media asset 132 that is downloaded from the media content provider 102. The billing service interface 136 at the media content provider 102 can associate a billing identifier 130 with the mobile phone 106, and communicate a charge 138 (e.g., a billing event) for the purchased media asset to the content billing service 126 at the communication service provider 104. The communication service provider 104 can then bill the user that is associated with the mobile phone 106 for the media asset 132 according to the charge 138 that is received from the media content provider. The user can be billed for a media asset in the mobile phone service bill that the user regularly receives from the communication service provider 104 for the phone data plan and communication service.

In the example system 100, a trust relationship is implemented between the mobile operator (e.g., the communication service provider 104) and the media content provider 102. Over-the-air data traffic is routed via the mobile communication link 114 from the communication service provider 104 to the media content provider. The media content provider 102 submits billable events, and corresponding billing identifiers 130, via the secure billing service interface 136 to the communication service provider 104 for media assets and/or services that are purchased by the user that utilizes the mobile phone 106 to facilitate the purchases. Traditionally, the mobile operator (e.g., the communication service provider 104) relies on the strength of a SIM based security scheme to authenticate a subscriber in order to lookup the ACR (e.g., billing identifier) via IMSI identifier. This operation can be utilized once the SIM processor proves knowledge of the corresponding key (referred to as K) that is shared with the mobile operator.

The communication service provider 104 can complete the SIM based authentication for mobile phone 106 to retrieve the ACR that is associated with the user of the mobile phone, and the ACR can then be communicated to the media content provider 102 over a secure channel between the communication service provider 104 and the media content provider 102. The techniques described herein provide that a single user with multiple SIMs 108, and who is a customer of the communication service provider 104, will have charges for purchased media assets and/or services show up on the appropriate bill that corresponds to a particular ACR.

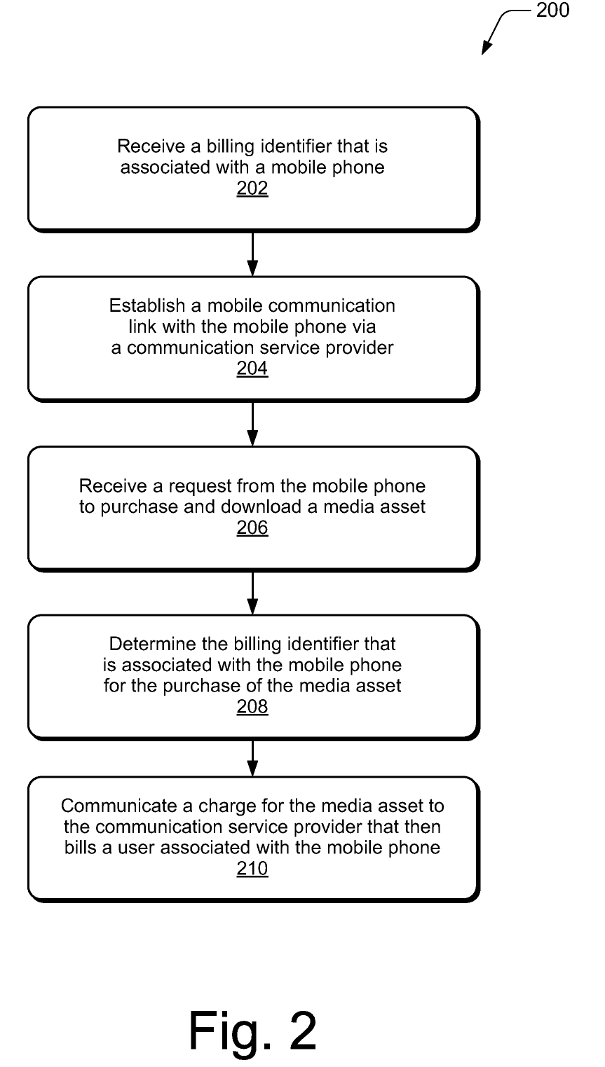

Example methods 200-500 are described with reference to respective FIGS. 2-5 in accordance with one or more embodiments of mobile phone billing for content payment. Generally, any of the functions, methods, procedures, components, and modules described herein can be implemented using hardware, software, firmware, fixed logic circuitry, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

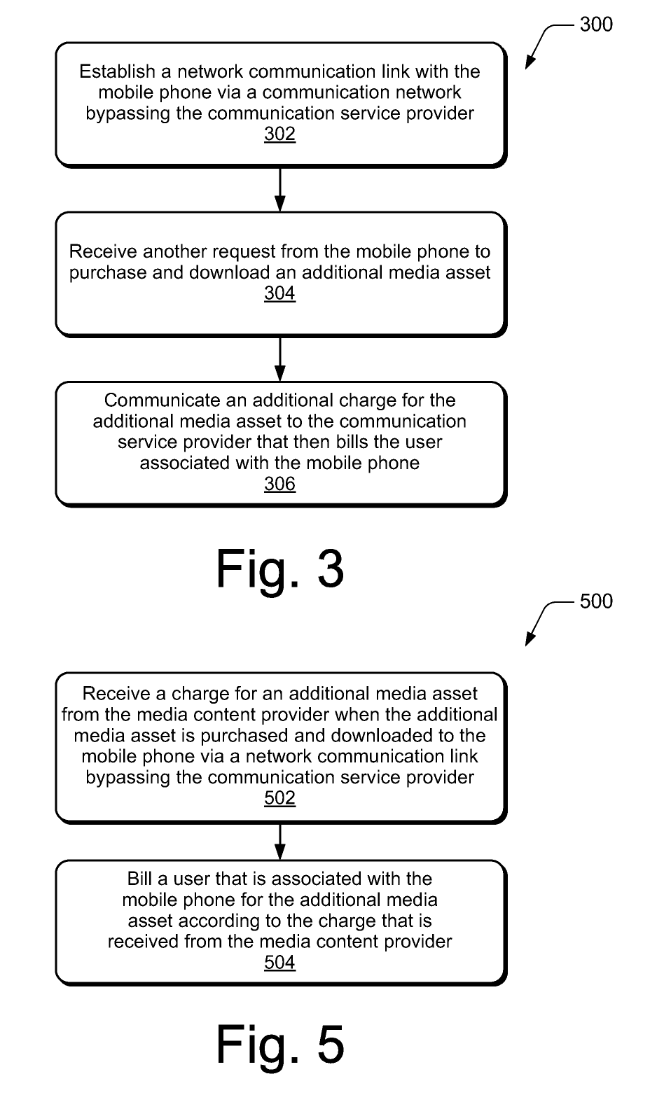

FIGS. 2 and 3 illustrate example methods 200 and 300 of mobile phone billing for content payment at a media content provider. The order in which the method blocks of each method are described are not intended to be construed as a limitation, and any number of the described method blocks can be combined in any order to implement a method, or an alternate method.

At block 202, a billing identifier is received that is associated with a mobile phone. For example, the media content provider 102 receives a billing identifier 130 that is associated with mobile phone 106. The billing identifier can be received from the communication service provider 104 that authenticates the mobile phone 106 for communications. At block 204, a mobile communication link is established with the mobile phone via the communication service provider. For example, the communication service provider 104 facilitates a mobile communication link 114 for communications between the mobile phone 106 and the media content provider 102.

At block 206, a request is received from the mobile phone to purchase and download a media asset. For example, a user can initiate a purchase of a media asset 132 that is downloaded to the mobile phone 106 from the media content provider 102. At block 208, the billing identifier that is associated with the mobile phone is determined for the purchase of the media asset. For example, the media content provider 102 determines the billing identifier 130 that is associated with the mobile phone 106 to initiate a charge for the purchased media asset. At block 210, a charge for the media asset is communicated to the communication service provider that then bills a user associated with the mobile phone. For example, the media content provider 102 communicates the charge 138 for the purchased media asset to the communication service provider 104 that then bills the user associated with the mobile phone.

To establish an initial connection with reference to method 200, the subscriber is authenticated to the mobile operator (e.g., the communication service provider 104). The mobile operator can issue a challenge, such as a randomly generated number, to the mobile phone that passes the challenge to a SIM 108 which signs the challenge using a key K that corresponds to a particular IMSI (K and the challenge are passed into a secure, one way function). The mobile phone can then pass the result back to the mobile operator that compares the SIM generated signature to its own computation using the K and the challenge. If the values are the same, then the SIM is authenticated and connection establishment can be completed at block 204. Both, the mobile operator and the SIM can derive a session key, Kses via K, and a challenge which is then used to provide integrity protection and optionally, confidentiality for all subsequent data exchanged between the mobile operator and the SIM 108 at mobile phone 106.

At block 206, of the example, the mobile phone can establish a secure, end-to-end channel between itself and the media content provider 102 with characteristics, such as the media content provider 102 is authenticated to the mobile phone 106 (e.g., based on an X509 certificate issued by a certification authority trusted by the mobile phone); the mobile phone 106 is authenticated to the media content provider 102 (e.g., based on an X509 certificate issued by a certification authority trusted by the media content provider); keying material is exchanged to facilitate the integrity and confidentiality of subsequent communications between the mobile phone 106 and the media content provider 102; the mobile phone 106 queries the SIM 108 for the IMSI1 and then sends the IMSI over a secure channel, and at block 202, the mobile operator also adds the billing identifier for the subscriber, such as an ACR that corresponds to an IMSI based on SIM authentication. The ACR is then used to add charges to a mobile phone service bill for the user at block 210 for media assets and/or services purchased at block 206.

In an implementation, the media content provider 102 persists the mapping between the credentials, IMSI and the ACR. This is implemented so that at a later point in time, such as when the user returns over a Wi-Fi connection as described with reference to FIG. 3, the media content provider 102 can use the credentials that the mobile phone authenticated in combination with the IMSI sent by the mobile phone to lookup the billing identifier 130 and submit a charge to the mobile operator (e.g., the communication service provider 104). The device credentials play the same role as SIM based authentication in the OTA case to facilitate billing charges, and the credentials can be implemented with sufficient strength (with SIM auth as a baseline) so as not to become the weakest link in the overall system. For example, the credentials can be implemented as an X509 certificate and corresponding private key (RSA 2048 bit key pair), where the private key is encrypted via a hardware protected key with OS level access control to a single privileged process.

Method 200 describes an over-the-air (OTA) data path with billing support. FIG. 3 illustrates a method 300 that continues from method 200 to describe a mobile phone subscriber using an Internet connection (i.e., not over-the-air) to initiate a purchase of media assets and/or services from the media content provider 102 utilizing the mobile phone 106 and having the transactions billed to the user that is associated with the mobile phone.

At block 302, a network communication link is established with the mobile phone via a communication network bypassing the communication service provider. For example, the network communication link 116 facilitates communication between the mobile phone 106 and the media content provider 102, while bypassing the communication service provider 104. At block 304, another request is received from the mobile phone to purchase and download an additional media asset. For example, a user can initiate a purchase of a media asset 132 that is downloaded to the mobile phone 106 from the media content provider 102 via the network communication link 116.

At block 306, an additional charge for the additional media asset is communicated to the communication service provider that then bills the user associated with the mobile phone for the additional media asset. For example, the media content provider 102 communicates the additional charge 138 for the additional purchased media asset to the communication service provider 104 that then bills the user associated with the mobile phone. The user that is associated with the mobile phone 106 is billed for the additional media asset in the mobile phone service bill.

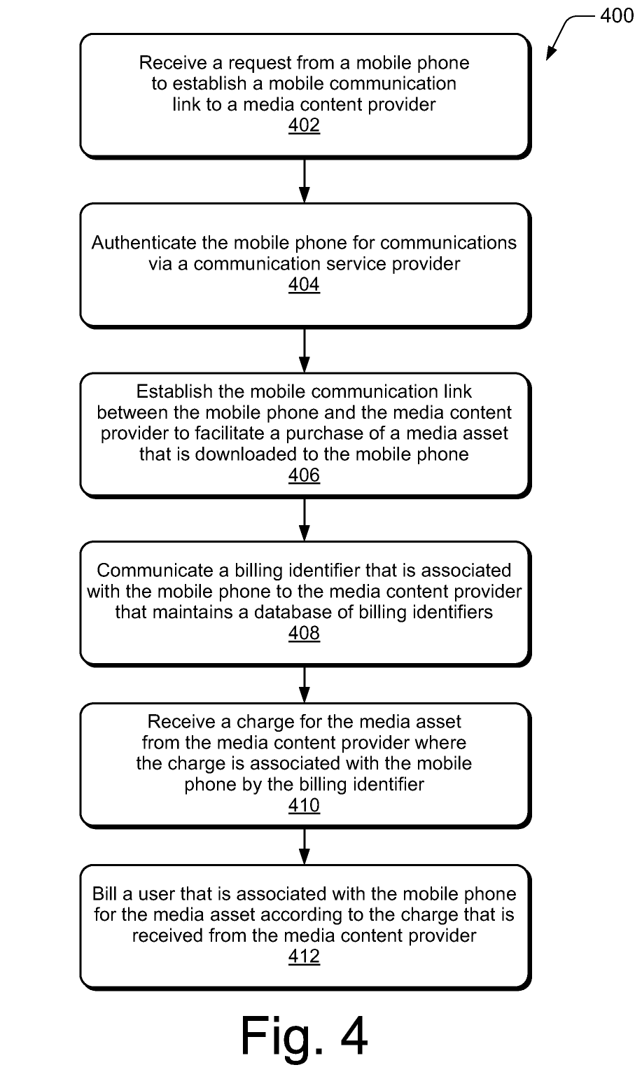

FIGS. 4 and 5 illustrate example methods 400 and 500 of mobile phone billing for content payment at a communication service provider. The order in which the method blocks of each method are described are not intended to be construed as a limitation, and any number of the described method blocks can be combined in any order to implement a method, or an alternate method.

At block 402, a request is received from a mobile phone to establish a mobile communication link to a media content provider. For example, the communication service provider 104 receives a request from the mobile phone 106 to establish the mobile communication link 114 to the media content provider 102 from which media assets can be purchased and downloaded. At block 404, the mobile phone is authenticated for communications via the communication service provider. For example, the authentication service 124 at the communication service provider 104 authenticates the mobile phone 106 to allow communications via the communication service provider.

At block 406, the mobile communication link between the mobile phone and the media content provider is established to facilitate a purchase of a media asset that is downloaded to the mobile phone. For example, a user can initiate a purchase of a media asset 132 that is downloaded to the mobile phone 106 from the media content provider 102. At block 408, a billing identifier that is associated with the mobile phone is communicated to the media content provider that maintains a database of billing identifiers. For example, the communication service provider 104 communicates a billing identifier 122 to the media content provider 102 that maintains the database of billing identifiers 130.

At block 410, a charge for the media asset is received from the media content provider, where the charge is associated with the mobile phone by the billing identifier. For example, the content billing service 126 at the communication service provider 104 receives a charge 138 via the billing service interface 136 at the media content provider 102 for the media asset that was purchased and downloaded to the mobile phone. At block 412, a user that is associated with the mobile phone is billed for the media asset according to the charge that is received from the media content provider. For example, the content billing service 126 at the communication service provider 104 bills the user that is associated with the mobile phone 106. The user is billed for the media asset in a mobile phone service bill that the user receives from the communication service provider 104.

FIG. 5 illustrates a method 500 that continues from method 400 in an embodiment of mobile phone billing for content payment.

At block 502, a charge is received for an additional media asset from the media content provider when the additional media asset is purchased and downloaded to the mobile phone via a network communication link bypassing the communication service provider. For example, the content billing service 126 at the communication service provider 104 receives an additional charge 138 via the billing service interface 136 at the media content provider 102 for the additional media asset that was purchased and downloaded to the mobile phone 106 via a network communication link 116 bypassing the communication service provider 104.

At block 504, the user that is associated with the mobile phone is billed for the additional media asset according to the charge that is received from the media content provider. For example, the content billing service 126 at the communication service provider 104 bills the user that is associated with the mobile phone 106. The user is billed for the additional media asset in a mobile phone service bill that the user receives from the communication service provider 104.

FIG. 6 illustrates various components of an example device 600 that can be implemented as any type of mobile phone, computer device, and/or server device as described with reference to FIG. 1 to implement embodiments of mobile phone billing for content payment. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of mobile phone billing for content payment. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 include a device manager 622 (e.g., a control application, software application, signal processing and control module, code that is native to a particular device, a hardware abstraction layer for a particular device, etc.). The device applications 618 also include any system components or modules to implement embodiments of mobile phone billing for content payment. In this example, the device applications 618 include a content billing service 624 that are shown as software modules and/or computer applications. Alternatively or in addition, the content billing service 624 can be implemented as hardware, software, firmware, or any combination thereof.

Device 600 also includes an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

Although embodiments of mobile phone billing for content payment have been described in language specific to features and/or methods, it is to be understood that the subject of the appended claims is not necessarily limited to the specific features or methods described. Rather, the specific features and methods are disclosed as example implementations of mobile phone billing for content payment.

1. A method implemented by a computer device at a communication service provider, the method comprising:
receiving a request from a mobile phone to establish a mobile communication link to a media content provider from which media assets can be purchased and downloaded;
authenticating the mobile phone for communications via the communication service provider;
establishing the mobile communication link between the mobile phone and the media content provider to facilitate a purchase of a media asset that is downloaded to the mobile phone;
communicating a billing identifier that is associated with the mobile phone to the media content provider that maintains a database of billing identifiers;
receiving a charge for the media asset from the media content provider, the charge for the media asset being associated with the mobile phone by the billing identifier; and
billing a user that is associated with the mobile phone for the media asset according to the charge for the media asset that is received from the media content provider, the user being billed in a mobile phone service bill.

2. A method as recited in claim 1, wherein the mobile phone corresponds to multiple billing accounts associated with the mobile phone service bill, and wherein the charge for the media asset is received with the billing identifier that correlates to a respective one of the multiple billing accounts.

3. A method as recited in claim 1, further comprising:
receiving an additional charge for an additional media asset from the media content provider, the additional charge for the additional media asset being associated with the mobile phone by the billing identifier, the additional media asset having been purchased and downloaded by the mobile phone via a network communication link bypassing the communication service provider; and
billing the user that is associated with the mobile phone for the additional media asset according to the additional charge that is received from the media content provider, the user being billed in the mobile phone service bill.

4. A method as recited in claim 3, wherein the mobile phone corresponds to multiple billing accounts associated with the mobile phone service bill, and wherein the additional charge for the additional media asset is received with the billing identifier that correlates to a respective one of the multiple billing accounts when bypassing the communication service provider.

5. A method as recited in claim 3, wherein the mobile communication link is over-the-air, and wherein the network communication link is Wi-Fi.

6. A method as recited in claim 1, wherein receiving the request from the mobile phone to establish the mobile communication link includes receiving a SIM identifier that is associated with the mobile phone, and wherein the mobile phone is authenticated using the SIM identifier.

7. A method as recited in claim 6, wherein the SIM identifier is communicated to the media content provider as the billing identifier that is associated with the mobile phone.

8. A method implemented by a computer device at a media content provider, the method comprising:
receiving a billing identifier that is associated with a mobile phone, the billing identifier being received from a communication service provider that authenticates the mobile phone for communications;
establishing a mobile communication link with the mobile phone via the communication service provider;
receiving a request from the mobile phone to purchase and download a media asset;
determining the billing identifier that is associated with the mobile phone for the purchase of the media asset; and
communicating a charge for the media asset to the communication service provider that then bills a user associated with the mobile phone for the media asset in a mobile phone service bill.

9. A method as recited in claim 8, wherein the mobile phone corresponds to multiple billing accounts associated with the mobile phone service bill, and wherein the charge for the media asset is communicated with the billing identifier that correlates to a respective one of the multiple billing accounts.

10. A method as recited in claim 8, further comprising:
establishing a network communication link with the mobile phone via a communication network, bypassing the communication service provider;
receiving another request from the mobile phone to purchase and download an additional media asset; and
communicating an additional charge for the additional media asset to the communication service provider that then bills the user associated with the mobile phone for the additional media asset in the mobile phone service bill.

11. A method as recited in claim 10, wherein the mobile communication link is established over-the-air via the communication service provider, and wherein the network communication link is an Internet connection bypassing the communication service provider.

12. A method as recited in claim 8, wherein the billing identifier is received as a SIM identifier that is associated with the mobile phone.

13. A method as recited in claim 12, wherein the SIM identifier is utilized to securely access a database of billing identifiers when the billing identifier is determined.

14. A method as recited in claim 12, wherein the charge for the media asset is communicated to the communication service provider along with the SIM identifier that is associated with the mobile phone.

15. A mobile communication system, comprising:
a mobile phone authentication service implemented by a computer device, the mobile phone authentication service configured to:
receive a request from a mobile phone to establish a mobile communication link to a media content provider from which media assets can be purchased and downloaded;
authenticate the mobile phone to establish the mobile communication link between the mobile phone and the media content provider to facilitate a purchase of a media asset that is downloaded to the mobile phone;
a communication service provider including at least a memory and a processor to implement a content billing service that is configured to:
communicate a billing identifier that is associated with the mobile phone to the media content provider that maintains a database of billing identifiers;
receive a charge for the media asset from the media content provider, the charge for the media asset being associated with the mobile phone by the billing identifier; and
bill a user that is associated with the mobile phone for the media asset according to the charge for the media asset that is received from the media content provider, the user being billed in a mobile phone service bill.

16. A mobile communication system as recited in claim 15, wherein the mobile phone corresponds to multiple billing accounts associated with the mobile phone service bill, and wherein the content billing service is further configured to receive the charge for the media asset with the billing identifier that correlates to a respective one of the multiple billing accounts.

17. A mobile communication system as recited in claim 15, wherein the content billing service is further configured to:
receive an additional charge for an additional media asset from the media content provider, the additional charge for the additional media asset being associated with the mobile phone by the billing identifier, the additional media asset having been purchased and downloaded by the mobile phone via a network communication link bypassing the communication service provider; and
bill the user that is associated with the mobile phone for the additional media asset according to the additional charge that is received from the media content provider, the user being billed in the mobile phone service bill.

18. A mobile communication system as recited in claim 17, wherein the mobile communication link is established over-the-air via the communication service provider, and wherein the network communication link is an Internet connection bypassing the communication service provider.

19. A mobile communication system as recited in claim 15, wherein the mobile phone authentication service is further configured to receive a SIM identifier that is associated with the mobile phone along with the request to establish the mobile communication link, and wherein the mobile phone is authenticated using the SIM identifier.

20. A mobile communication system as recited in claim 19, wherein the content billing service is further configured to communicate the SIM identifier to the media content provider as the billing identifier that is associated with the mobile phone.
